(19) United States
(12) Patent Application Publication
(10) Pub. No.: US 2006/0242762 A1
(43) Pub. Date: Nov. 2, 2006

(54) Bed system for a mobile vehicle

(76) Inventors: Arielle Drummond, Pittsburgh, PA (US); Patrick Hvozdik, Port Vue, PA (US); Peter M. Pontano, Seattle, WA (US); Byung Kim, Mission Viejo, CA (US); Megan M. Stanton, Long Beach, CA (US); A. James Cipriani, Pittsburgh, PA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/400,117

(22) Filed: Apr. 7, 2006

Related U.S. Application Data
(60) Provisional application No. 60/669,662, filed on Apr. 7, 2005.

(51) Int. Cl. A47C 17/80; B60P 3/38

(52) U.S. Cl. 5/118; 296/190.02

(57) ABSTRACT

A stowable bed system for a mobile vehicle. The stowable bed system includes two operating rails, and a fixed upper box for receiving and stowing a vertically movable bed. The operating rails 109 are engaged to each of the sleeper side walls within the sleeper compartment of a vehicle. The fixed upper box is engaged to the upper ends of the operating rails near the top of the sleeper compartment. The vertically movable bed is engaged between and at each end to one of the operating rails. The movable bed may be moved upwards along the operating rails to be stowed under or within the fixed upper box. The movable bed is used for sleeping in the lower position along the operating rails.

This patent issues from a non-provisional patent application claiming the priority of provisional patent application Ser. No. 60/669,662, filed Apr. 7, 2005.

### BACKGROUND

Trucks carry a bulk of the goods within the United States. Driver's have a difficult lifestyle in which they spend much of their time within the cab and sleeper of their over the road tractor trailers. They must comply with federal regulations in the United States that limit the amount of time behind the wheel. The truck becomes their home away from home. The sizing constraints of the sleeper berth are a well-known hurdle to truck manufactures. Increased weight constraints, reduced turning radius, shorter overall carry length and extremely expensive changes in manufacturing infrastructure prohibit longer sleepers. Therefore the sleeper configuration represents the practical maximum length that a manufacturer would be willing to provide to drivers and the standard choice for team operations; some even refer to this model as a “team vehicle”. Few design variations, however, differentiate how two people use the space versus a “single driver vehicle” such as a low roof or one bunk bed.

Isolation is the private mode where the downtime driver has a chance to separate themselves and “get away”. The public side allows for shared space while still preserving each driver's personal items. What holds these two worlds together is the retractable beds. By pushing them out of the way, drivers can ensure privacy of personal sleep space and create new living space for daytime recreation or work. This invention provides a stowable bed that will allow for maximizing both the public and private side of the sleeper.

### SUMMARY

This invention relates to a stowable bed system for a mobile vehicle. The stowable bed system includes two operating rails, and a fixed upper box for receiving and stowing a vertically movable bed. The operating rails are engaged to each of the sleeper side walls within the sleeper compartment of a vehicle. The fixed upper box is engaged to the upper ends of the operating rails near the top of the sleeper compartment. The vertically movable bed is engaged between and at each end to one of the operating rails. The movable bed may be moved upwards along the operating rails to be stowed under or within the fixed upper box. The movable bed is used for sleeping in the lower position along the operating rails.

### DRAWINGS

Other objects and advantages of the invention will become more apparent upon perusal of the detailed description thereof and upon inspection of the drawings, in which:

FIG. 1 is a side view of a mobile vehicle with a stowable bed system made in accordance with the invention installed.

FIG. 2 is an internal perspective view of the sleeper compartment of the mobile vehicle of FIG. 1 showing the stowable bed system with a movable bed in a lower sleep position.

FIG. 3 is an internal perspective view of the sleeper compartment of the mobile vehicle of FIG. 1 showing the stowable bed system with a movable bed in a raised stowed position.

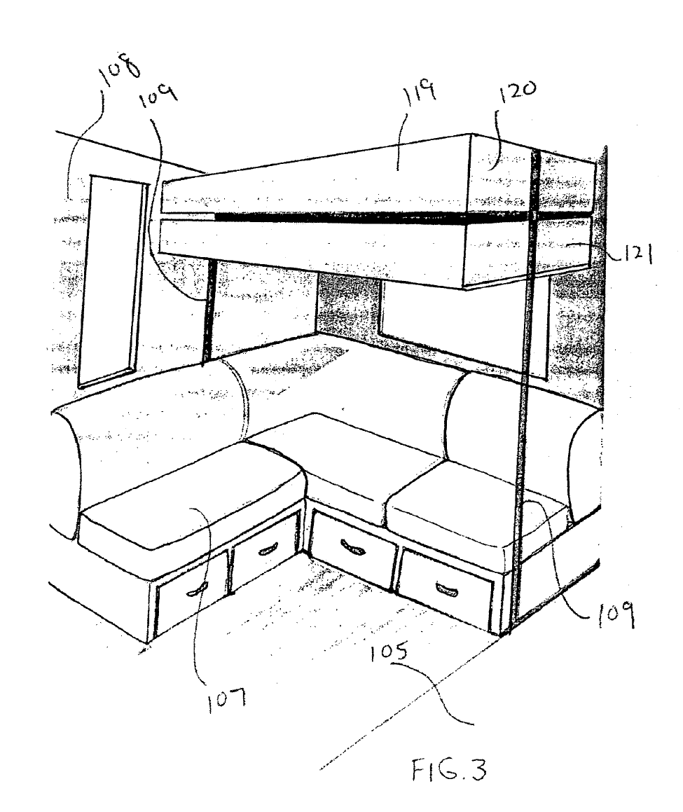

FIG. 4 is cross sectional view of the stowable bed system.

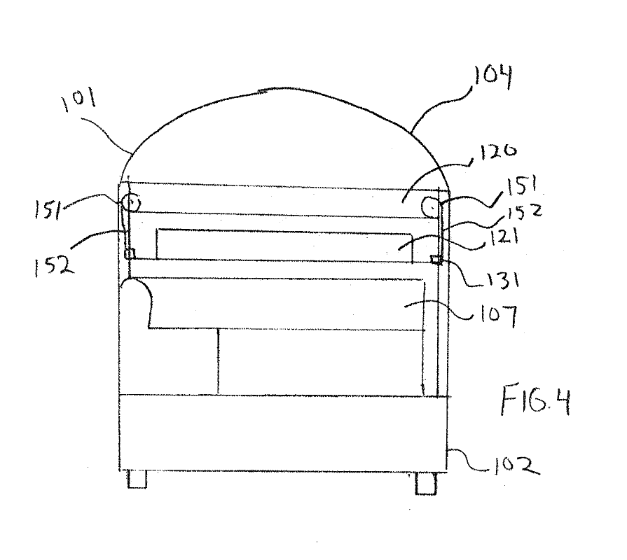

### DESCRIPTION OF INVENTION

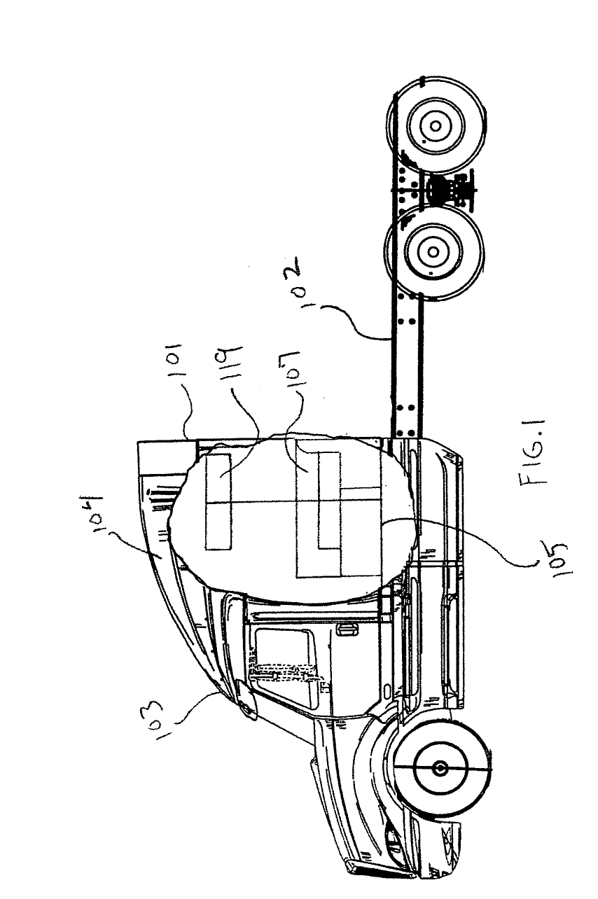

A motor vehicle 101, specifically a tractor trailer, includes a cab 103 engaged to a drive train bearing chassis 102. For over the road tractors, there will be a sleeper compartment 104 that includes a driver living space. The sleeper compartment 104 includes a mounting floor 105 as well as the off duty living space for the driver or drivers. The off duty living space is defined partially by sleeper side walls 108. The vehicle 101 shown in FIG. 1 has a stowable bed system 119 made in accordance with the invention mounted within the sleeper compartment 104. There may be a couch 107 engaged onto the mounting floor 105 in the vicinity of the stowable bed system 119 in the rearward portion of the sleeper compartment 104.

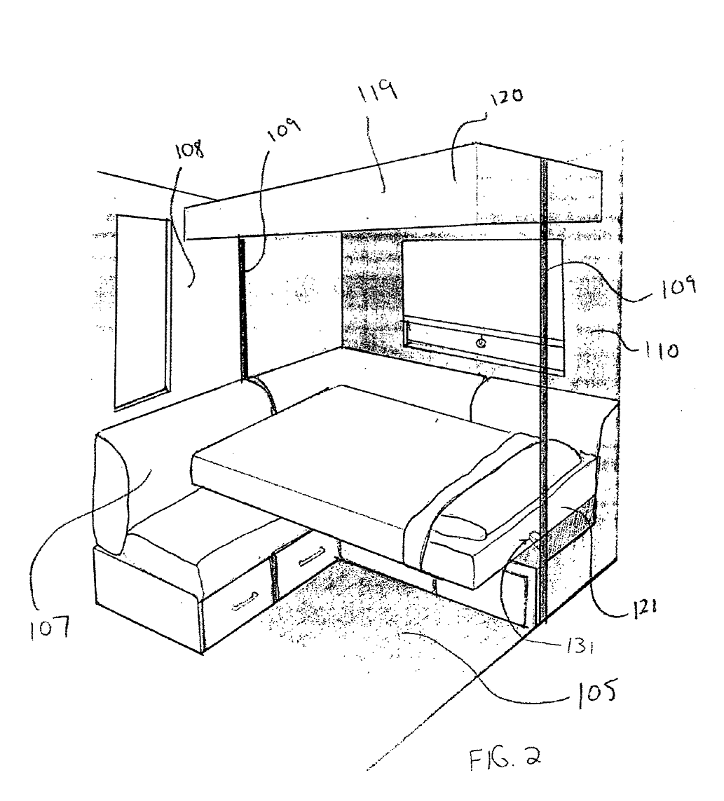

The stowable bed system 119 is generally comprised of two operating rails 109, and a fixed upper box 120 for receiving and stowing a vertically movable bed 121. The operating rails 109 are engaged to each of the sleeper side walls 108. The fixed upper box 120 is engaged to the upper ends of the operating rails 109 near the top of the sleeper compartment 104. The vertically movable bed 121 is engaged between and at each end to one of the operating rails 109. The movable bed 121 may be moved upwards along the operating rails 109 to be stowed under or within the fixed upper box 120 as shown in FIG. 2. The operating rails 109 may be installed over the couch 107, which may be contoured to cover the rear wall 110 of the sleeper compartment 104 as well at least part of one of the sleeper side walls 108. This allows the vertically movable bed 121 to be lowered along the operating rails 109 to just above the couch 107 as shown in 2. This is the best location for sleeping on the movable bed 121. When the movable bed 121 is not to be used for sleeping, the bed 121 may be moved upwards to the fixed upper box 120 allowing increased socializing and relaxing room on the couch 107. The movable bed 121 may be engaged on a bed bracket 131 that rides within the operating rails 109. The movable bed 121 may be moved upwards using two variable load spring counterbalances 151 that having engaging cables 152 for providing moving tension to the bed brackets 131 and hence the movable bed 121.

The final product form will reflect the vertical movement of the bed. The interaction of the drivers and the bed will be the focal point of the design solution. For this interaction is the solution that solves the problem of balancing public and private space. The feeling that the space has when the bed is up should change significantly when the bed is down. Materials and textures used to create these two different spaces should transition smoothly from one setting to the other. However the ritualistic feeling of “going to bed” should not be lost. Therefore the act of pulling down the bed will take on greater significance to the driver. The surfaces that the driver must interact with during the moving of the bed and the force with which the driver will have to employ to position his bed must be easy and relaxing in tune with the ritualistic feeling of ending ones day. The form language of the sub-dominant and subordinate components will again be designed in compliment with the dominant components. Plush cushioning of the living space for example may balance out the structural components of the bed lifting mechanism. Treatments of the floor and ceiling may also reflect the motion and transition that the bedroom affords.

The product concept has two major components; a vertical moving bed on a track system and a pliable noise control curtain that can be configured in a variety of positions. The moving bed system consists of two beds connected to two vertical tracks. The tracks are located at the head and the foot of the bed and bisect the longitudinal centerline of the bed. The tracks will be similar to roller tracks used for sliding doors and industrial purposes. The bed structures consist of the appropriate interaction points to allow movement in the vertical directions along the track. The interaction points will have wheels to provide smooth movement. To aid in the movement of the beds, two variable load spring counterbalances are used. The variable load counterbalances will allow the beds to be easily adjusted in height and maintain vertical position when there is no additional load applied. When it is desired to have one or both of the beds secured into the “up” position, a track lock system will be engaged. This lock must be robust to support the weight of a human while in the bed.

Additionally, a factor of safety will be added in to account for variable body weight, unexpected load combinations, and fatigue caused by road movements. To aid in the preservation of bedding aspect, the bed structures will be designed to create a shallow enclosure when the beds are vertically oriented together. This will ensure that the bedding on the lower bunk does not come into contact with the bottom of the upper bunk.

The track and beds are to be made of steel framing. The bed housing will be injection molded with a semi rigid thermoplastic. The individual components of the bed system will be purchased from mass production wholesale. These parts include nuts, bolts, bearings, spring counterbalances, and wheels. The components will be put together in house at one of International's manufacturing plants.

As described above, the stowable bed system of this invention and vehicle made with the stowable bed system provide a number of advantages, some of which have been described above and others of which are inherent in the invention. Also modifications may be proposed to the stowable bed system of this invention and vehicle made with the stowable bed system without departing from the teachings herein.

We claim

1. A mobile vehicle in combination with a stowable bed system, comprising:
a cab engaged to a drive train bearing chassis;
a sleeper compartment including a driver living space;
said sleeper compartment including a mounting floor as well as off duty living space for a driver;
said off duty living space partially defined by sleeper side walls generally perpendicular to said mounting floor;
a stowable bed system mounted within said sleeper compartment;
said stowable bed system having two operating rails engaged to each of said sleeper side walls;
a fixed upper box being engaged to upper ends of said operating rails near a top of said sleeper compartment;
a vertically movable bed engaged between and at each end to one of said operating rails;
said movable bed movable upwards along said operating rails to be stowed under or within the fixed upper box; and
said movable bed movable downwards along said operating rails to a sleeping position.

2. The mobile vehicle of claim 1, wherein:
said operating rails being installed over a couch;
said couch contoured to cover a rear wall of said sleeper compartment as well at least part of one of said sleeper side walls, allowing said vertically movable bed to be lowered along said operating rails to just above said couch.

3. The mobile vehicle of claim 1, wherein:
said movable bed may be moved upwards using two variable load spring counterbalances having engaging cables for providing moving tension to said movable bed.
